(19) United States
(12) Patent Application Publication
(10) Pub. No.: US 2013/0113725 A1
(43) Pub. Date: May 9, 2013

(54) DISPLAY SYSTEM AND CONTROL METHOD THEREOF

(71) Applicants: Jeong-ryeol SEO, Seongnam-si (KR); Jae-seung SHIM, Hwaesong-si (KR); Jin-ho SON, Hanam-si (KR); Yun-suk CHOI, Suwon-si (KR)

(72) Inventors: Jeong-ryeol SEO, Seongnam-si (KR); Jae-seung SHIM, Hwaesong-si (KR); Jin-ho SON, Hanam-si (KR); Yun-suk CHOI, Suwon-si (KR)

(73) Assignee: SAMSUNG ELECTRONICS CO., LTD., Suwon-si (KR)

(21) Appl. No.: 13/477,816

(22) Filed: May 22, 2012

(30) Foreign Application Priority Data
Nov. 9, 2011 (KR) 10-2011-0116568

(51) Int. Cl. G06F 3/041

(52) U.S. Cl. 345/173

(57) ABSTRACT

A display system, including a plurality of display apparatuses, is disclosed. The display system includes: a plurality of display apparatuses each of which includes a display unit, a user input unit, and a controller which sets a display ID according to a user's selection and controls the display unit to generate a display identification signal corresponding to the set display ID; a pointing device which, if a display unit is touched, determines a display ID of the touched display unit, calculates coordinate information of a touched position of the touched display unit based on the display identification signal of the touched display unit, and transmits, to a server, the display ID and the coordinate information of the touched position; and an image processing apparatus which displays, on a display unit corresponding to the determined display ID, an image corresponding to the calculated coordinate information of the touched position.

### CROSS-REFERENCE TO RELATED APPLICATION

This application claims priority from Korean Patent Application No. 10-2011-0116568, filed on Nov. 9, 2011 in the Korean Intellectual Property Office, the disclosure of which is incorporated herein by reference in its entirety.

### BACKGROUND

1. Field

Apparatuses and methods consistent with exemplary embodiments relate to a display system and a control method thereof, and more particularly, to a video wall display system which includes a plurality of display apparatuses and a control method thereof

2. Description of the Related Art

A plasma display panel (PDP) includes a screen which displays an image as the pixels thereof are discharged. When a pointing device detects a discharge waveform caused by the PDP, then, an image is displayed on the PDP corresponding to a detected position on the PDP.

If a video wall display system which includes a plurality of PDPs is formed, discharge waveforms which are caused by various of the plurality of PDPs are the same and thus the pointing device may not be able to detect which display panel is being indicated by the pointing device.

### SUMMARY

One or more exemplary embodiments may provide a video wall display system and a control method thereof which includes a plurality of display apparatuses and enables a pointing device to determine which display apparatus is being identified by the pointing device.

According to an aspect of an exemplary embodiment, a display system includes: a plurality of display apparatuses each of which includes a display unit, a user input unit, and a controller which sets a display ID according to a user's selection and controls the display unit to generate a display identification signal corresponding to the set display ID; a pointing device which, if a display unit of one of the plurality of display apparatuses is touched, determines a display ID of the touched display unit, calculates coordinate information of a touched position of the touched display unit based on the display identification signal of the touched display unit, and transmits, to a server, the display ID and the coordinate information of the touched position; and an image processing apparatus which displays, on a display unit corresponding to the determined display ID, an image corresponding to the calculated coordinate information of the touched position, on a display unit.

For each display unit of the plurality of display apparatuses, the display identification signal may include a reference signal that is different based on the display ID of the display unit, and a scanning signal that is scanned to the display unit at the same timing in a row direction and a column direction of the display unit.

Each of the plurality of display apparatuses may further include a storage unit which stores therein a plurality of display IDs, each associated with one of a plurality of reference signals.

Each of the plurality of display apparatuses may further include a user interface (UI) generator which generates a menu button for setting a display ID by selecting one of the plurality of display IDs stored in the storage unit, and the controller may control the UI generator to generate and display the menu button on the display unit of one of the plurality of display apparatuses and may control the display unit to generate a reference signal corresponding to the display ID selected through the menu button if a particular key input is received through the user input unit.

Each of a plurality of reference signals may include a plurality of pulses and each of the plurality of reference signals may comprise a different pulse pattern, such that each of the plurality of reference signals corresponds to one of the plurality of display IDs based on the pulse pattern of the reference signal.

Each of the plurality of reference signals may include different time intervals between the plurality of pulses, such that each of the plurality of reference signals corresponds to one of the plurality of display IDs based on the time intervals between the plurality of pulses of the reference signal.

Each of the plurality of reference signals may include a different number of pulses, such that each of the plurality of reference signals corresponds to one of the plurality of display IDs based on the number of pulses of the reference signal.

Each of the plurality of reference signals may include different time during which the plurality of pulses has a preset voltage level or higher, such that each of the plurality of reference signals corresponds to one of the plurality of display IDs based on the time during which the reference signal has the preset voltage level or higher.

The pointing device may include a sensor which senses the display identification signal, a communication unit which communicates with the image processing apparatus, and a controller which determines the display ID based on the reference signal, calculates coordinate information of the touched position based on the scanning signal, and controls the communication unit to transmit the determined display ID and the calculated coordinate information of the touched position to the image processing apparatus.

The pointing device may further include a storage unit which stores therein a plurality of display IDs, each associated with one of a plurality of reference signals.

The display unit may include a plasma display panel (PDP).

According to an aspect of another exemplary embodiment, a control method of a display system includes: setting a display ID of a display unit of each of a plurality of display apparatuses according to a user's selection; generating a display identification signal on the display unit of each of the plurality of display apparatuses; sensing a display identification signal of a display unit, of one of the plurality of display apparatuses, touched by a pointing device; determining the display ID of the touched display unit based on the sensed display identification signal and calculating coordinate information of a touched position; and displaying an image corresponding to the calculated coordinate information of the touched position, on the touched display unit.

For each display unit of the plurality of display apparatuses, the display identification signal may include a reference signal that is different based on the display ID of the display unit, and a scanning signal that is scanned to the display unit at the same timing in a row direction and a column direction of the display unit.

The control method may further include storing, in a storage unit of each of the display apparatuses, a plurality of display IDs, each associated with one of a plurality of reference signals.

The control method may further include generating a menu button for setting a display ID by selecting one of the plurality of display IDs stored and displaying the menu button on the display unit of one of the plurality of display apparatuses.

Each of a plurality of the reference signals may include a plurality of pulses, and each of the plurality of reference signals may include a different pulse pattern, such that each of the plurality of reference signals corresponds to one of the plurality of display IDs based on the pulse pattern of the reference signal.

Each of the plurality of reference signals may include different time intervals between the plurality of pulses, such that each of the plurality of reference signals corresponds to one of the plurality of display IDs based on the time intervals between the plurality of pulses.

Each of the plurality of reference signals may include a different number of pulses, such that each of the plurality of reference signals corresponds to one of the plurality of display IDs based on the number of pulses of the reference signal.

Each of the plurality of reference signals may include different time during which the plurality of pulses has a preset voltage level or higher, such that each of the plurality of reference signals corresponds to one of the plurality of display IDs based on the time during which the reference signal has the voltage level or higher.

The calculating the coordinate information of the touched position may include determining the display ID based on the reference signal of the sensed display identification signals and calculating coordinate information of the touched position based on the scanning signal; and transmitting the determined display ID and the calculated coordinate information of the touched position to an image processing apparatus.

The control method may further include storing in the pointing device a plurality of display IDs, each associated with one of a plurality of reference signals.

The display unit may include a plasma display panel.

According to an aspect of another exemplary embodiment, a pointing device of a display system includes: a communication unit which communicates with an image processing apparatus that transmits an image signal to a plurality of display apparatuses; a storage unit which stores therein a plurality of display IDs, each associated with one of a plurality of reference signals; a sensor which senses a display identification signal generated by a display unit, of one of the plurality of display apparatuses, touched by the pointing device; and a controller which determines a display ID of the touched display unit based on a reference signal included in the sensed display identification signal, calculates coordinate information of a touched position based on a scanning signal comprised in the sensed display identification signal, and controls the communication unit to transmit the determined display ID and the calculated coordinate information of the touched position to the image processing apparatus.

### BRIEF DESCRIPTION OF THE DRAWINGS

The above and/or other exemplary aspects will become apparent and more readily appreciated from the following description of exemplary embodiments, taken in conjunction with the accompanying drawings, in which:

FIG. 1 illustrates a display system according to an exemplary embodiment;

FIG. 2 is a control block diagram of a plurality of display apparatuses and a pointing device;

FIG. 3 illustrates an exemplary embodiment of a first storage unit of the display apparatus in FIG. 2;

FIG. 4 illustrates an exemplary embodiment of a menu button that is generated by a user interface (UI) generator of the display apparatus in FIG. 2;

FIGS. 5 and 6 illustrate an exemplary embodiment of a display identification signal which is generated from the display apparatus in FIG. 2; and

FIG. 7 is a control flowchart of the display system in FIG. 1.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

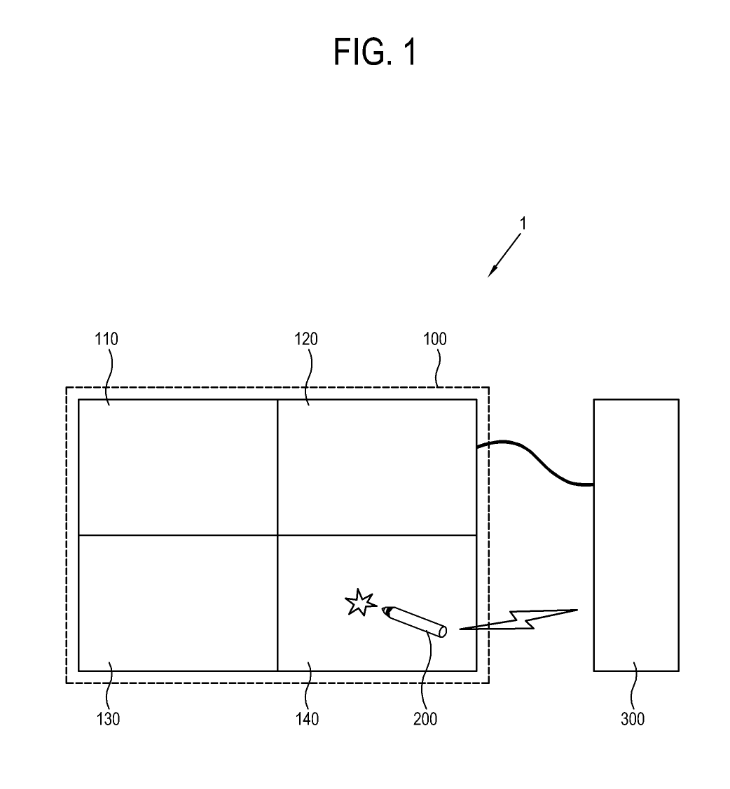

FIG. 1 illustrates a display system according to an exemplary embodiment.

As shown in FIG. 1, a display system 1 includes a plurality 100 of display apparatuses which each display an image thereon, a pointing device 200 which touches a predetermined position of each display unit of the plurality of display apparatuses, and an image processing apparatus 300 which transmits an image to the display apparatuses 100.

Display apparatuses 110, 120, 130 and 140 of the plurality 100 of display apparatuses may each include a TV or a computer monitor which includes a display unit. The plurality 100 of display apparatuses may form a video wall display. In the present exemplary embodiment, a video wall display is formed by four display apparatuses, but the number of display apparatuses which form the video wall display is not limited thereto.

The pointing device 200 touches one of the display units of the plurality 100of display apparatuses, and calculates coordinate information of the touched position of the display unit. The pointing device 200 transmits the coordinate information of the touched position to the image processing apparatus 300.

The image processing apparatus 300 processes an image corresponding to the touched position of the pointing device 200 based on the coordinate information of the touched position transmitted by the pointing device 200, and transmits the image to the display apparatus for display.

The pointing device 200, according to the present exemplary embodiment, detects a display identification signal generated by the plurality of display apparatuses, identifies a touched display apparatus from among the plurality of display apparatuses, and calculates coordinate information of the touched position. The pointing device 200 transmits to the image processing apparatus 300 the information on the touched display apparatus among the plurality of display apparatuses and the coordinate information of the touched position, and the image processing apparatus 300 transmits an image corresponding to the coordinate information to the touched display apparatus to display the image in the display apparatus.

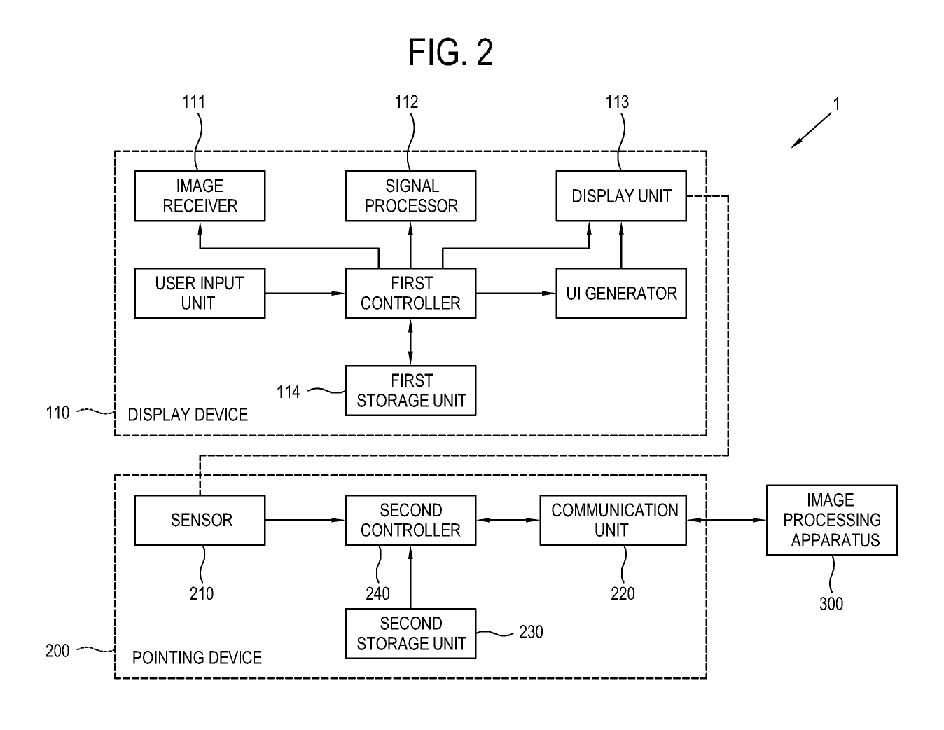

Hereinafter, the plurality 100 of display apparatuses and the pointing device 200 will be described in more detail with reference to FIG. 2.

Referring to FIG. 2, each of the respective display apparatuses 110, 120, 130 and 140 of the plurality 100 of display apparatuses includes an image receiver 111, a signal processor 112, a display unit 113, a user input unit 114, a user interface (UI) generator 114, a storage unit 116 and a first controller 117 which controls the foregoing elements.

The image receiver 111 receives an image signal from the outside and transmits the image signal to the signal processor 112. The image receiver 111 may vary corresponding to the standard of the received image signal. For example, the image receiver 111 may receive an image signal including a radio frequency (RF) signal, and an image signal according to a standard such as composite/component video, super video, Syndicat des Constructeurs d'Appareils Radioruper video, outside and (SCART), a high definition multimedia interface (HDMI), display port, unified display interface (UDI) or wireless HD standard. The image receiver 111 may receive an image signal from the image processing apparatus 300.

The signal processor 112 processes the image signal that is transmitted by the image receiver 111 and transmits the processed image signal to the display unit 113. The image processing operation of the signal processor 112 may, solely or collectively, include analog/digital conversion (ADC), demodulating, decoding, deinterlacing, scaling and detail-enhancing operations and a frame refresh rate converting operation. The signal processor 112 may be provided as individual configurations for performing each image processing operation independently, or a system-on chip (SoC) as an integrated configuration for integrating several functions.

The display unit 113 displays thereon an image corresponding to an image signal that is output by the signal processor 112. The display unit 113 according to the present exemplary embodiment includes a plasma display panel (PDP). The PDP is a flat panel display which uses a gas discharge (plasma) phenomenon, and includes two slim glass substrates in which a transparent electrode formed in horizontal and vertical directions and mixed gas including neon and xenon is injected and a voltage is applied. Then, a discharge occurs between an anode and a cathode and creates an ultraviolet ray. This ultraviolet ray is emitted to a fluorescent material to display an image. The display unit 113 generates a display identification signal by a control of the controller 116, and this display identification signal is generated in the form of a discharge waveform. The display identification signal includes a reference signal that varies by a display ID, and a scanning signal that is scanned to the display unit 113 at the same timing in a row direction and a column direction of the display unit 113. The display identification signal will be described in more detail when the first controlled 117 is described.

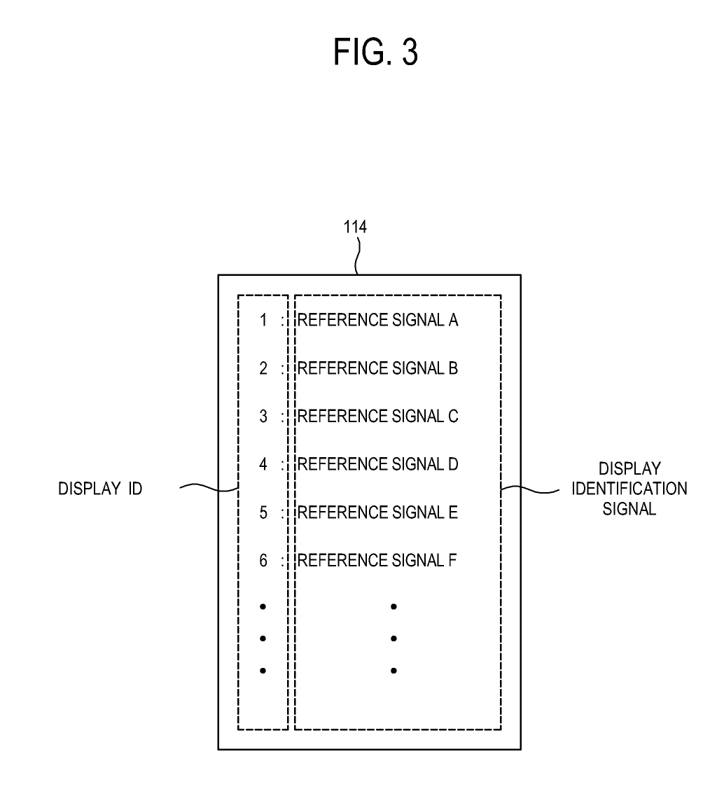

The first storage unit 114 stores therein a plurality of display IDs and reference signal information corresponding to each display ID. FIG. 3 illustrates an exemplary embodiment of the first storage unit 114 of the display apparatus 110. Referring to FIG. 3, the first storage unit 114 stores therein Arabic numbers 1, 2, 3, 4, 5, 6, . . . as a plurality of display IDs, together with a reference signal A, a reference signal B, a reference signal C, a reference signal D, a reference signal E, a reference signal F, . . . corresponding to each of the plurality of display IDs. Arabic numbers are an example of the display IDs, which may otherwise be stored.

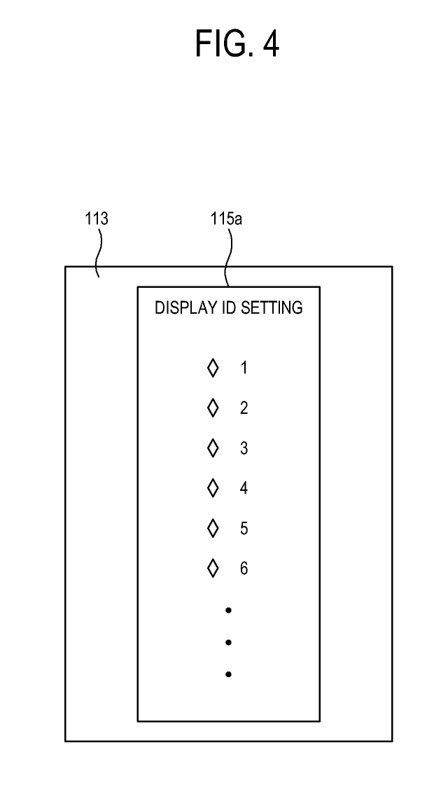

The UI generator 115 generates a menu button for setting a display ID and displays the menu button on the display unit 113 by a control of the first controller 117. FIG. 4 illustrates an exemplary embodiment of the menu button generated by the UI generator 115 of the display apparatus 110. The UI generator 115 will be described with reference to FIG. 4. If a particular key is input through the user input unit 116 (to be described later), the UI generator 115 generates a menu button for setting a display ID and displays the menu button on the display unit 113 by a control of the first controller 117. The menu button which is generated by the UI generator 115 includes an item for selecting one of a plurality of display IDs stored in the first storage unit 114. A user selects a desired display ID through the user input unit 116 among the plurality of display IDs displayed on the display unit 113. The first controller 117 sets a display ID for the display unit 113 according to the user's selection, and controls the display unit 113 to generate a display identification signal including a stored reference signal corresponding to the selected display ID.

By a user's manipulation, the user input unit 116 generates and transmits a preset command to the display apparatus 110 in connection with various control operations of the display apparatus 110. The user input unit 116 may be any of various forms of user input which can be manipulated by a user. The user input unit 116 may be provided as a button in the display apparatus 110, or as a touch panel, or a remote controller that is installed remotely from the display apparatus 110 and which communicates with the display apparatus 110, or a smart phone including an application performing a remote control function.

The first controller 117 sets a display ID according to the user's selection and controls the display unit 113 to generate a display identification signal on the display unit 113 corresponding to the set display ID. Upon receiving a particular key input from the user input unit 116, the first controller 117 controls the UI generator 115 to generate a menu button to select one of a plurality of display IDs stored in the first storage unit 114 and display the menu button on the display unit 113. If one of the display IDs is selected by a user's selection, the first controller 117 controls the display unit 113 to generate a display identification signal including a reference signal stored in the first storage unit 114 corresponding to the selected display ID.

The display identification signal includes a reference signal that varies according to the display ID and a scanning signal that is scanned to the display unit 113 at the same timing in a row direction and a column direction of the display unit 113. The display identification signal is generated in the form of a discharge waveform in each pixel of the display unit 113 including a PDP. In the display identification signal, the reference signal is generated first and then the scanning signal follows. The display identification signal is included in an image signal by the signal processor 112 and is output to the display unit 113. This enables the display unit 113 to scan a display identification signal.

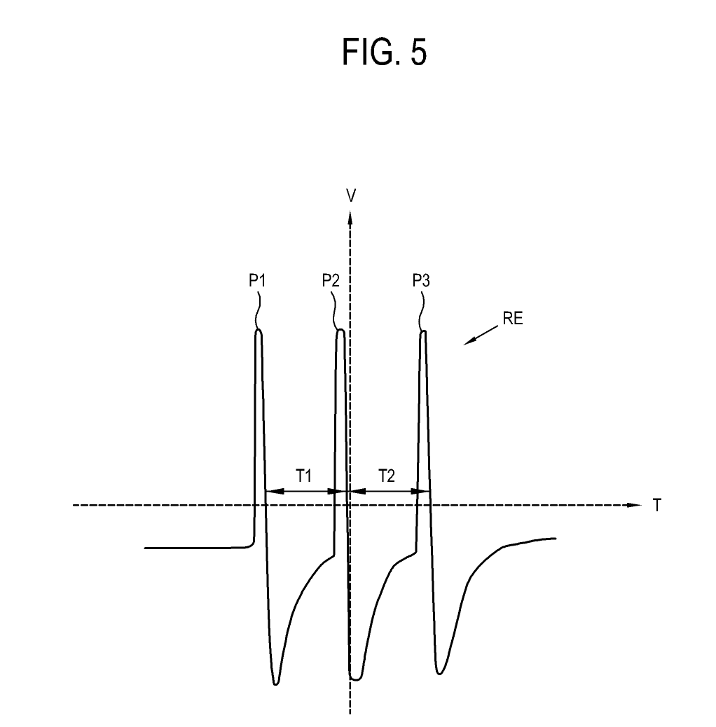

FIG. 5 illustrates an exemplary embodiment of a reference signal that is included in a display identification signal generated by the display unit 113 of the display apparatus 110. Referring to FIG. 5, in a graph in which the x-axis is time (T) and the y-axis is voltage (V), a reference signal includes three pulses P1, P2 and P3. If a time interval between the pulses P1 and P2 is T1 and a time interval between the pulses P2 and P3 is T2,an adjustment of the time intervals T1 and T2 may determine which reference signal is associated with the waveform. For example, the T1 of the reference signal A corresponding to the display ID 1 is 30 μsec, and T2 thereof is 40 μsec; the T1 of the reference signal B corresponding to the display ID 2 is 40 μsec and T2 thereof is 30 μsec; a T1 of the reference signal C corresponding to the display ID 2 is 30 μsec and T2 thereof is 50 μsec; a T1 of a reference signal D corresponding to the display ID 4 is 50 μsec and T2 thereof is 30 μsec; a T1 of a reference signal E corresponding to the display ID 5 is 40 μsec and T2 thereof is 50 μsec; and a T1 of a reference signal F corresponding to the display ID 6 is 50 μsec and T2 thereof is 40 μsec.

As another example of setting a waveform of a reference signal, there are three pulses of waveforms of the reference signal in FIG. 5, but the number of the pulses of the reference signal may vary. For example, the reference signal A may have 3 pulses; the reference signal B may have 4 pulses; the reference signal C may have 5 pulses; the reference signal D may have 6 pulses; the reference signal E may have 7 pulses and the reference signal F may have 8 pulses.

As another example of setting a waveform of a reference signal, it may be set by varying the size of the voltage of the pulse of the reference signal.

Accordingly, the waveform of the reference signal may be set in one of various ways, including not only those described above.

Returning to FIG. 2, the pointing device 200 includes a sensor 210, a communication unit 220, a second storage unit 230 and a second controller 240.

If a predetermined position of the display unit 113 of the display apparatus 110 is touched, the sensor 210 senses a display identification signal generated by the display unit 113. The sensor 210 is provided at an external end of the pointing device 200 and is realized in consideration of properties of the display identification signal. The sensor 210 transmits a sensing result of the display identification signal to the second controller 240.

The second storage unit 230 stores therein a plurality of display IDs and a plurality of reference signal information corresponding to each display ID. The information stored in the second storage unit 230 is the same as that stored in the first storage unit 114, and repetitive description will be omitted.

The second controller 240 determines a display ID and calculates coordinate information of the touched position based on the sensing result transmitted by the sensor 210.

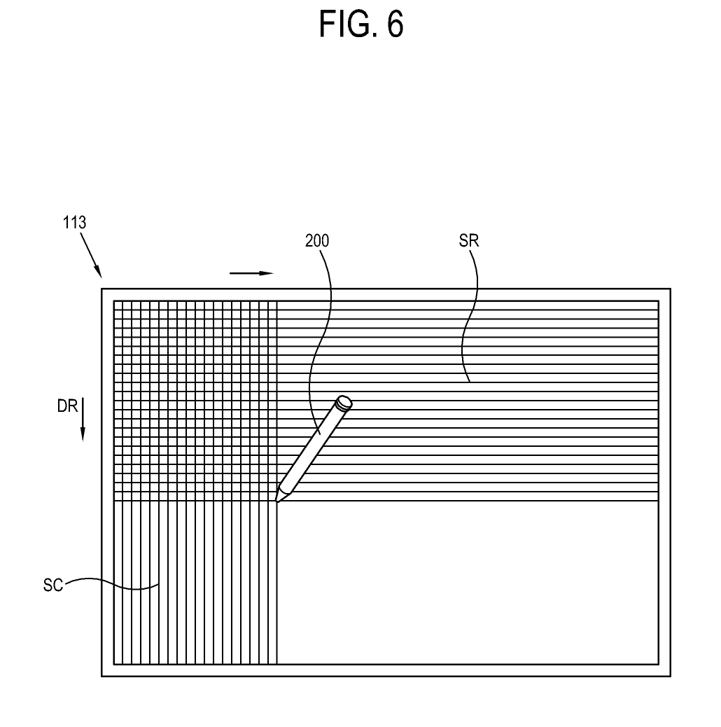

The second controller 240 determines the display ID of the display apparatus 110 and calculates the coordinate information of the touched position based on the sensed display identification signal. The calculation of the coordinate information of the touched position will be described with reference to FIG. 6. FIG. 6 illustrates an exemplary embodiment of a scanning signal that is included in the display identification signal. Referring to FIG. 6, the scanning signal is sequentially scanned in a row direction DR and a column direction DC of the display unit 113 after the reference signal is generated, and includes a scanning signal SR scanned in the x-axis direction and a scanning signal SC scanned in the y-axis direction. On the display unit 113, following the reference signal, the scanning signal SR in the x-axis direction is sequentially scanned from the top to the bottom, and then the scanning signal SC in the y-axis direction is sequentially scanned from the left side to the right side. The sensor 210 of the pointing device 200 senses the scanning signal SR in the x-axis direction and the scanning signal SC in the y-axis direction from the touched position of the pointing device 200. Accordingly, the second controller 240 calculates the time interval from the sensing of the reference signal by the sensor 210 to the sensing of the scanning signal SR in the x-axis direction, and calculates the x-axis value of the touched position of the pointing device 200 corresponding to the calculated time interval. The second controller 240 calculates the time interval from the sensing of the scanning signal SR in the x-axis direction sensed by the sensor 210 to the sensing of the scanning signal SC in the y-axis direction and calculates the y-axis value of the touched position of the pointing device 200 corresponding to the calculated time interval. That is, the second controller 240 calculates the abscissa and ordinate, or x- and y-coordinates of the touched position.

The second controller 240 determines a waveform of the reference signal sensed by the sensor 210 and determines a display ID corresponding to the determined reference signal based on the information stored in the second storage unit 230.

The communication unit 210 transmits to the image processing apparatus 300 the determined display ID and the coordinate information on the touched position of the pointing device 200 by a control of the second controller 240. The communication unit 210 wirelessly communicates with the image processing apparatus 300, and may communicate according to a preset wireless communication protocol. For example, the communication unit 210 may transmit and receive data based on RF communication standards such as Zigbee, and transmit and receive data through a particular frequency band, i.e., a preset wireless communication channel.

Upon receiving the display ID and coordinate information on the touched position from the communication unit 210 of the pointing device 200, the image processing apparatus 300 transmits an image signal corresponding to coordinate information of the touched position to the display apparatus corresponding to the display ID. The image processing apparatus 300 may communicate with the pointing device 200 and the plurality of display apparatuses 100. The image processing apparatus 300 may receive the display ID and coordinate information on the touched position from the pointing device 200, and receive display ID information set by a user from each of the plurality of display apparatuses 100. Accordingly, the image processing apparatus 300 may transmit an image corresponding to the coordinate information transmitted by the pointing device 200 to the display apparatus corresponding to the display ID transmitted by the pointing device 200. The image processing apparatus 300 may include a computer main body such as a desktop computer or a laptop computer.

In the present exemplary embodiment, the image processing apparatus 300 is an electronic device that is separated from the plurality 100of display apparatuses, but not limited thereto. Alternatively, the image processing apparatus 300 may be designed to be included in a single housing together with the plurality 100of display apparatuses.

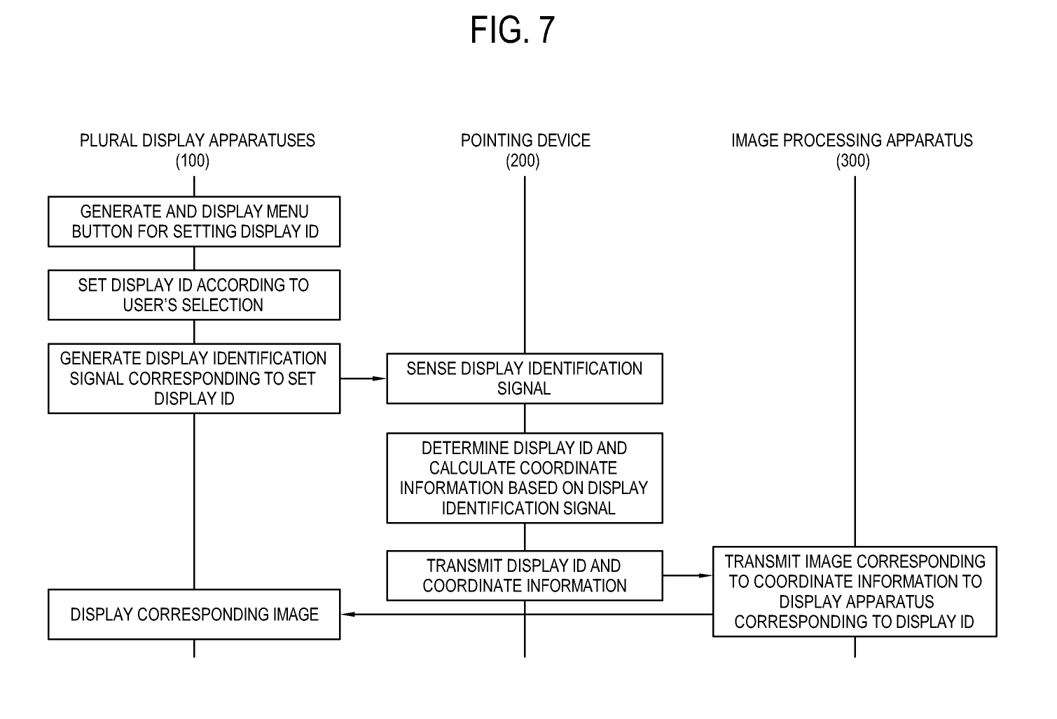

FIG. 7 is a control flowchart of a display system according to an exemplary embodiment.

Referring to FIGS. 1 and 7, if the plurality 100 of display apparatuses including the first display apparatus 110, the second display apparatus 120, the third display apparatus 130, and the fourth display apparatus 140 is realized as a video wall display, a user may set a display ID for each of the display apparatuses 110, 120, 130 and 140. For example, upon receiving a particular key input through the user input unit 116 with respect to the first display apparatus 110, the controller 117 controls the UI generator 115 to generate a menu button for setting a display ID among a plurality of display IDs stored in the storage unit 114 and to display the menu button on the display unit 130. The controller 117 may set the display ID of the display apparatus 110 according to a user's selection that is made through the displayed menu button, e.g., set the display ID as a display ID 1. Then, the controller 117 controls the display unit 113 of the first display apparatus 110 to generate a display identification signal including a reference signal A corresponding to the display ID 1. In the same manner, a user may set a display ID 2 for the second display apparatus 120, and the controller of the second display apparatus 120 controls the display unit of the second display apparatus 120 to generate a display identification signal including a reference signal B corresponding to the display ID 2. If a display ID 3 is set for the third display apparatus 130 in the same manner, the display unit of the third display apparatus 130 generates a display identification signal including a reference signal C corresponding to the display ID 3. If a display ID 4 is set for the fourth display apparatus 140, the display unit of the fourth display apparatus 140 generates a display identification signal including a reference signal D corresponding to the display ID 4.

If the pointing device 200 touches the display unit of any one of the first to fourth display apparatuses, it senses the display identification signal that is generated by the relevant display unit. If the pointing device 200 touches the display unit of the first display apparatus 110, the sensor 210 of the pointing device 200 senses the display identification signal including the reference signal A and transmits the signal to the controller 240 of the pointing device 200. The controller 240 determines that the display ID is 1 based on the reference signal A, and calculates coordinate information of the touched position of the pointing device 200 from the scanning signal included in the display identification signal. The display ID and the coordinate information of the touched position as determined above is transmitted to the image processing apparatus 300 through the communication unit 210 of the pointing device 200.

The image processing apparatus 300 transmits the image signal corresponding to the received coordinate information of the touched position to the first display apparatus 110 corresponding to the display ID 1.

The first display apparatus 110 displays on the display unit the image signal corresponding to the coordinate information of the touched position transmitted by the image processing apparatus 300.

As described above, exemplary embodiments describe a display system and a control method which enables a pointing device to determine which display apparatus among a plurality of display apparatuses forming a video wall display is being contacted.

Although a few exemplary embodiments have been shown and described, it will be appreciated by those skilled in the art that changes may be made in these exemplary embodiments without departing from the principles and spirit of the invention, the range of which is defined in the appended claims and their equivalents.

What is claimed is:

1. A display system comprising:
a plurality of display apparatuses each of which comprises a display unit, a user input unit, and a controller which sets a display ID according to a user's selection and controls the display unit to generate a display identification signal corresponding to the set display ID;
a pointing device which, if a display unit of one of the plurality of display apparatuses is touched, determines a display ID of the touched display unit, calculates coordinate information of a touched position of the touched display unit based on the display identification signal of the touched display unit, and transmits, to a server, the display ID and the coordinate information of the touched position; and
an image processing apparatus which displays, on a display unit corresponding to the determined display ID, an image corresponding to the calculated coordinate information of the touched position.

2. The display system according to claim 1, wherein, for each display unit of the plurality of display apparatuses, the display identification signal comprises a reference signal that is different based on the display ID of the display unit, and a scanning signal that is scanned to the display unit at the same timing in a row direction and a column direction of the display unit.

3. The display system according to claim 2, wherein each of the plurality of display apparatuses further comprises a storage unit which stores therein a plurality of display IDs, each associated with one of a plurality of reference signals.

4. The display system according to claim 3, wherein each of the plurality of display apparatuses further comprises a user interface (UI) generator which generates a menu button for setting a display ID by selecting one of the plurality of display IDs stored in the storage unit, and the controller controls the UI generator to generate and display the menu button on the display unit of one of the plurality of display apparatuses and controls the display unit to generate a reference signal corresponding to the display ID selected through the menu button if a particular key input is received through the user input unit.

5. The display system according to claim 2, wherein each of a plurality of reference signals comprises a plurality of pulses and each of the plurality of reference signals comprises a different pulse pattern, such that each of the plurality of reference signals corresponds to one of the plurality of display IDs based on the pulse pattern of the reference signal.

6. The display system according to claim 5, wherein each of the plurality of reference signals comprises different time intervals between the plurality pulses, such that each of the plurality of reference signals corresponds to one of the plurality of display IDs based on the time intervals between the plurality of pulses of the reference signal.

7. The display system according to claim 5, wherein each of the plurality of reference signals comprises a different number of pulses, such that each of the plurality of reference signals corresponds to one of the plurality of display IDs based on the number of pulses of the reference signal.

8. The display system according to claim 5, wherein each of the plurality of reference signals comprises different time during which the plurality of pulses has a preset voltage level or higher, such that each of the plurality of reference signals corresponds to one of the plurality of display IDs based on the time during which the reference signal has the preset voltage level or higher.

9. The display system according to claim 2, wherein the pointing device comprises a sensor which senses the display identification signal, a communication unit which communicates with the image processing apparatus, and a controller which determines the display ID based on the reference signal, calculates coordinate information of the touched position based on the scanning signal, and controls the communication unit to transmit the determined display ID and the calculated coordinate information of the touched position to the image processing apparatus.

10. The display system according to claim 9, wherein the pointing device further comprises a storage unit which stores therein a plurality of display IDs, each associated with one of a plurality of reference signals.

11. The display system according to claim 1, wherein the display unit comprises a plasma display panel.

12. A control method of a display system, the control method comprising:
setting a display ID of a display unit of each of a plurality of display apparatuses, according to a user's selection;
generating a display identification signal on the display unit of each of the plurality of display apparatuses;
sensing a display identification signal of a display unit, of one of the plurality of display apparatuses, touched by a pointing device;
determining the display ID of the touched display unit based on the sensed display identification signal and calculating coordinate information of a touched position; and
displaying an image, corresponding to the calculated coordinate information of the touched position, on the touched display unit.

13. The control method according to claim 12, wherein, for each display unit of the plurality of display apparatuses, the display identification signal comprises a reference signal that is different based on the display ID of the display unit, and a scanning signal that is scanned to the display unit at the same timing in a row direction and a column direction of the display unit.

14. The control method according to claim 13, further comprising storing, in a storage unit of each of the display apparatuses, a plurality of display IDs, each associated with one of a plurality of reference signals.

15. The control method according to claim 14, further comprising generating a menu button for setting a display ID by selecting one of the plurality of display IDs stored and displaying the menu button on the display unit of one of the plurality of display apparatuses.

16. The control method according to claim 13, wherein each of a plurality of the reference signals comprises a plurality of pulses, and each of the plurality of reference signals comprises a different pulse pattern, such that each of the plurality of reference signals corresponds to one of the plurality of display IDs based on the pulse pattern of the reference signal.

17. The control method according to claim 16, wherein each of the plurality of reference signals comprises different time intervals between the plurality of pulses, such that each of the plurality of reference signals corresponds to one of the plurality of display IDs based on the time intervals between the plurality of pulses.

18. The control method according to claim 16, wherein each of the plurality of reference signals comprises a different number of pulses, such that each of the plurality of reference signals corresponds to one of the plurality of display IDs based on the number of pulses of the reference signal.

19. The control method according to claim 16, wherein each of the plurality of reference signals comprises different time during which the plurality of pulses has a preset voltage level or higher, such that each of the plurality of reference signals corresponds to one of the plurality of display IDs based on the time during which the reference signal has the preset voltage level or higher.

20. The control method according to claim 13, wherein the calculating the coordinate information of the touched position comprises determining the display ID based on the reference signal of the sensed display identification signal and calculating coordinate information of the touched position based on the scanning signal; and
transmitting the determined display ID and the calculated coordinate information of the touched position to an image processing apparatus.

21. The control method according to claim 20, further comprising storing in the pointing device a plurality of display IDs, each associated with one of a plurality of reference signals.

22. The control method according to claim 12, wherein the display unit comprises a plasma display panel.

23. A pointing device of a display system comprising:
a communication unit which communicates with an image processing apparatus that transmits an image signal to a plurality of display apparatuses;
a storage unit which stores therein a plurality of display IDs, each associated with one of a plurality of reference signals;
a sensor which senses a display identification signal generated by a display unit, of one of the plurality of display apparatuses, touched by the pointing device; and
a controller which determines a display ID of the touched display unit based on a reference signal comprised in the sensed display identification signal, calculates coordinate information of a touched position based on a scanning signal comprised in the sensed display identification signal, and controls the communication unit to transmit the determined display ID and the calculated coordinate information of the touched position to the image processing apparatus.
